(19) United States
(12) Patent Application Publication
(10) Pub. No.: US 2017/0126580 A1
(43) Pub. Date: May 4, 2017

(54) Tracking Contention in a Distributed Business Transaction

(71) Applicant: AppDynamics, Inc., San Francisco, CA (US)

(72) Inventors: Jason Lo, San Francisco, CA (US); Vinay Srinivasaiah, San Carlos, CA (US)

(21) Appl. No.: 14/928,827

(22) Filed: Oct. 30, 2015

(51) Int. Cl. H04L 12/911; H04L 12/26

(52) U.S. Cl. CPC H04L 47/741; H04L 43/065

(57) ABSTRACT

A system tracks and reports contention between two or more threads for a resource in the course of performing a business transaction. Contention tracking, including an indication of whether a thread that is executing an application is waiting for a desired resource to be unlocked, is reported in the context of a business transaction handled by the particular thread that is using or waiting for resource. A resource may be any element that can be accessed or requested by a thread, including but not limited to an object, hardware component, database, or other resource. As a result, an entire view of the business transaction may be analyzed, including the time spent waiting for another resource to be available. This enables system administrators to troubleshoot system in ways not possible before, including determining whether additional objects or resources should be provided to avoid delays caused by contention between threads.

### BACKGROUND

The World Wide Web has expanded to provide numerous web services to consumers. The web services may be provided by a web application which uses multiple services and applications to handle a transaction. The applications may be distributed over several machines, making the topology of the machines that provide the service more difficult to track and monitor.

Monitoring a web application helps to provide insight regarding bottle necks in communication, communication failures and other information regarding performance of the services that provide the web application. Most application monitoring tools provide a standard report regarding application performance. Though the typical report may be helpful for most users, it may not provide the particular information that an administrator wants to know.

For example, most application performance monitor systems can monitor time it takes for an application to perform a task. This helps provide insight into application performance, but does not provide any information regarding the active or passive time spent by the application. What is needed is an improved method for monitoring the performance of an application.

### SUMMARY

The present technology, roughly described, tracks and reports contention between two or more threads for a resource such as an object in the course of performing a business transaction. Contention tracking, including an indication of whether a thread that is executing an application is waiting for a desired object or other resource to be unlocked, is reported in the context of a business transaction handled by the particular thread that is using or waiting for resource. As a result, an entire view of the business transaction may be analyzed, including the time spent waiting for another resource to be available. This may enable system administrators to troubleshoot their system in ways not possible before, including determining whether additional objects or resources should be provided to avoid delays for retrieving or obtaining access to that particular object or resource.

An embodiment may include a method for monitoring a business transaction performed by multiple computers. The method begins with sampling by a first agent a thread on a first computer. The first agent may be installed on the first computer, wherein the first computer may be one of a plurality of computers that host an application which processes a business transaction. The business transaction may be performed by applications on the plurality of the computers. The first agent may determine that, based on the sampling, the thread is in waiting for a resource that is locked. Thread wait data and data for the locked resource may be stored. The thread wait data, the locked resource data, and business transaction data may be transmitted by the first agent to a remote server. The remote server may report the thread data with business transaction data received from the first agent and a second agent installed on a second computer of the plurality of computers.

An embodiment may include a system for monitoring a business transaction performed by multiple computers. The system may include a processor, memory, and one or more modules stored in memory and executable by the processor. When executed, the modules may sample by a first agent a thread on a first computer, the first agent installed on the first computer, the first computer one of a plurality of computers that host an application which processes a business transaction, the business transaction performed by applications on the plurality of the computers, determine by the first agent based on the sampling that the thread is in waiting for a resource that is locked, store thread wait data and data for the locked resource, and transmit the thread wait data, the locked resource data, and business transaction data by the first agent to a remote server, the remote server reporting the thread data with business transaction data received from the first agent and a second agent installed on a second computer of the plurality of computers.

### BRIEF DESCRIPTION OF THE DRAWINGS

FIG. 1 is a block diagram of a system for monitoring a distributed business transaction.

FIG. 2 is a method for monitoring a distributed business transaction.

FIG. 3 is a method for collecting resource contention data by an agent.

FIG. 4 is a method for analyzing and reporting data by a server.

FIG. 5 is an illustration of a graphical user interface for reporting thread contention information.

FIG. 6 is a block diagram of a computing environment for implementing the present technology.

### DETAILED DESCRIPTION

The present technology, roughly described, tracks and reports contention between two or more threads for a resource in the course of performing a business transaction. Contention tracking, including an indication of whether a thread that is executing an application is waiting for a desired resource to be unlocked, is reported in the context of a business transaction handled by the particular thread that is using or waiting for resource. A resource may be any element that can be accessed or requested by a thread, including but not limited to an object, hardware component, database, or other resource. As a result, an entire view of the business transaction may be analyzed, including the time spent waiting for another resource to be available. This may enable system administrators to troubleshoot their system in ways not possible before, including determining whether additional objects or resources should be provided to avoid delays for retrieving or obtaining access to that particular object or resource.

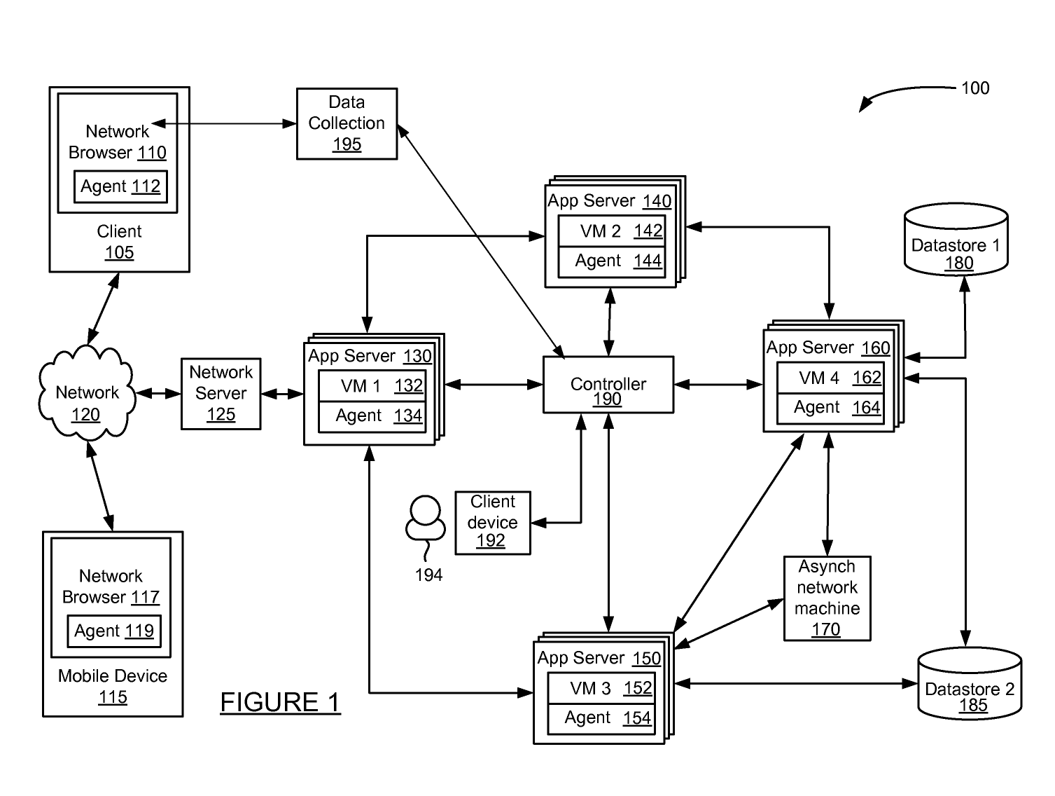

FIG. 1 is a block diagram of a system for monitoring a distributed business transaction. System 100 of FIG. 1 includes client device 105 and 192, mobile device 115, network 120, network server 125, application servers 130, 140, 150 and 160, asynchronous network machine 170, data stores 180 and 185, controller 190, and data collection server 195.

Client device 105 may include network browser 110 and be implemented as a computing device, such as for example a laptop, desktop, workstation, or some other computing device. Network browser 110 may be a client application for viewing content provided by an application server, such as application server 130 via network server 125 over network 120.

Network browser 110 may include agent 112. Agent 112 may be installed on network browser 110 and/or client 105 as a network browser add-on, downloading the application to the server, or in some other manner. Agent 112 may be executed to monitor network browser 110, the operation system of client 105, and any other application, API, or other component of client 105. Agent 112 may determine network browser navigation timing metrics, access browser cookies, monitor code, and transmit data to data collection 160, controller 190, or another device. Agent 112 may perform other operations related to monitoring a request or a network at client 105 as discussed herein.

Mobile device 115 is connected to network 120 and may be implemented as a portable device suitable for sending and receiving content over a network, such as for example a mobile phone, smart phone, tablet computer, or other portable device. Both client device 105 and mobile device 115 may include hardware and/or software configured to access a web service provided by network server 125.

Mobile device 115 may include network browser 117 and an agent 119. Mobile device may also include client applications and other code that may be monitored by agent 119. Agent 119 may reside in and/or communicate with network browser 117, as well as communicate with other applications, an operating system, APIs and other hardware and software on mobile device 115. Agent 119 may have similar functionality as that described herein for agent 112 on client 105, and may repot data to data collection server 160 and/or controller 190.

Network 120 may facilitate communication of data between different servers, devices and machines of system 100 (some connections shown with lines to network 120, some not shown). The network may be implemented as a private network, public network, intranet, the Internet, a cellular network, Wi-Fi network, VoIP network, or a combination of one or more of these networks. The network 120 may include one or more machines such as load balance machines and other machines.

Network server 125 is connected to network 120 and may receive and process requests received over network 120. Network server 125 may be implemented as one or more servers implementing a network service, and may be implemented on the same machine as application server 130 or one or more separate machines. When network 120 is the Internet, network server 125 may be implemented as a web server.

Application server 130 communicates with network server 125, application servers 140 and 150, and controller 190. Application server 130 may also communicate with other machines and devices (not illustrated in FIG. 1). Application server 130 may host an application or portions of a distributed application. The host application 132 may be in one of many platforms, such as including a Java, PHP, .Net, and Node.JS, be implemented as a Java virtual machine, or include some other host type. Application server 130 may also include one or more agents 134 (i.e. “modules”), including a language agent, machine agent, and network agent, and other software modules. Application server 130 may be implemented as one server or multiple servers as illustrated in FIG. 1.

Application 132 and other software on application server 130 may be instrumented using byte code insertion, or byte code instrumentation (BCI), to modify the object code of the application or other software. The instrumented object code may include code used to detect calls received by application 132, calls sent by application 132, and communicate with agent 134 during execution of the application. BCI may also be used to monitor one or more sockets of the application and/or application server in order to monitor the socket and capture packets coming over the socket.

In some embodiments, server 130 may include applications and/or code other than a virtual machine. For example, server 130 may include Java code, .Net code, PHP code, Ruby code, C code or other code to implement applications and process requests received from a remote source.

Agents 134 on application server 130 may be installed, downloaded, embedded, or otherwise provided on application server 130. For example, agents 134 may be provided in server 130 by instrumentation of object code, downloading the agents to the server, or in some other manner. Agents 134 may be executed to monitor application server 130, monitor code running in a or a virtual machine 132 (or other program language, such as a PHP, .Net, or C program), machine resources, network layer data, and communicate with byte instrumented code on application server 130 and one or more applications on application server 130.

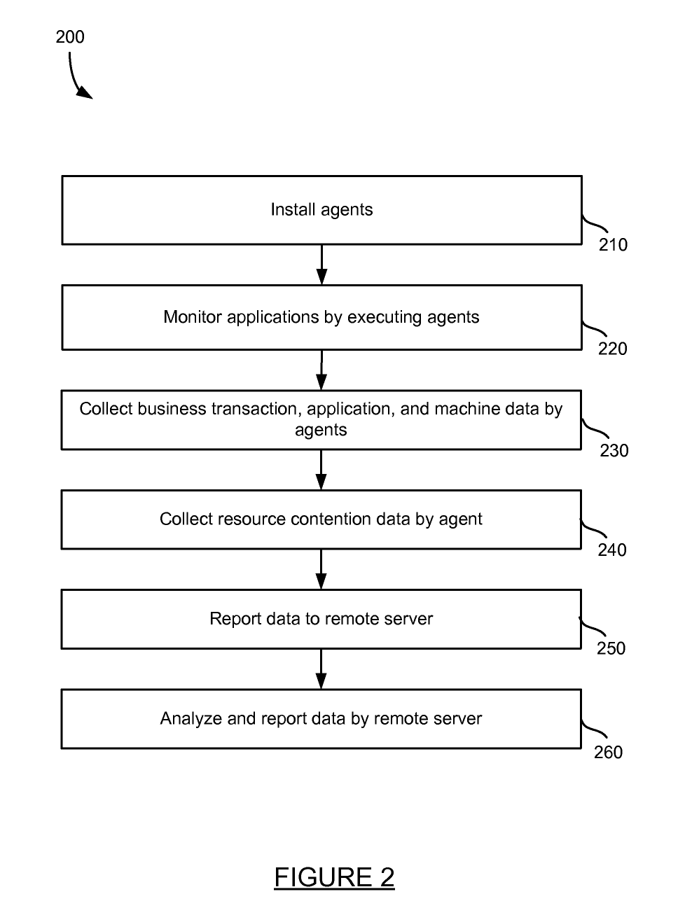

Each of agents 134, 144, 154 and 164 may include one or more agents, such as a language agents, machine agents, and network agents. A language agent may be a type of agent that is suitable to run on a particular host. Examples of language agents include a JAVA agent, .Net agent, PHP agent, and other agents. The machine agent may collect data from a particular machine on which it is installed. A network agent may capture network information, such as data collected from a socket. Agents are discussed in more detail below with respect to FIG. 2.

Agent 134 may detect operations such as receiving calls and sending requests by application server 130, resource usage, and incoming packets. Agent 134 may receive data, process the data, for example by aggregating data into metrics, and transmit the data and/or metrics to controller 190. Agent 134 may perform other operations related to monitoring applications and application server 130 as discussed herein. For example, agent 134 may identify other applications, share business transaction data, aggregate detected runtime data, and other operations.

An agent may operate to monitor a node, tier or nodes or other entity. A node may be a software program or a hardware component (e.g., memory, processor, and so on). A tier of nodes may include a plurality of nodes which may process a similar business transaction, may be located on the same server, may be associated with each other in some other way, or may not be associated with each other.

A language agent may be an agent suitable to instrument or modify, collect data from, and reside on a host. The host may be a Java, PHP, .Net, Node.JS, or other type of platform. Language agent 220 may collect flow data as well as data associated with the execution of a particular application. The language agent may instrument the lowest level of the application to gather the flow data. The flow data may indicate which tier is communicating which with which tier and on which port. In some instances, the flow data collected from the language agent includes a source IP, a source port, a destination IP, and a destination port. The language agent may report the application data and call chain data to a controller. The language agent may report the collected flow data associated with a particular application to network agent 230.

A network agent may be a standalone agent that resides on the host and collects network flow group data. The network flow group data may include a source IP, destination port, destination IP, and protocol information for network flow received by an application on which network agent 230 is installed. The network agent 230 may collect data by intercepting and performing packet capture on packets coming in from a one or more sockets. The network agent may receive flow data from a language agent that is associated with applications to be monitored. For flows in the flow group data that match flow data provided by the language agent, the network agent rolls up the flow data to determine metrics such as TCP throughput, TCP loss, latency and bandwidth. The network agent may then reports the metrics, flow group data, and call chain data to a controller. The network agent may also make system calls at an application server to determine system information, such as for example a host status check, a network status check, socket status, and other information.

A machine agent may reside on the host and collect information regarding the machine which implements the host. A machine agent may collect and generate metrics from information such as processor usage, memory usage, and other hardware information.

Each of the language agent, network agent, and machine agent may report data to the controller. Controller 210 may be implemented as a remote server that communicates with agents located on one or more servers or machines. The controller may receive metrics, call chain data and other data, correlate the received data as part of a distributed transaction, and report the correlated data in the context of a distributed application implemented by one or more monitored applications and occurring over one or more monitored networks. The controller may provide reports, one or more user interfaces, and other information for a user.

Agent 134 may create a request identifier for a request received by server 130 (for example, a request received by a client 105 or 115 associated with a user or another source). The request identifier may be sent to client 105 or mobile device 115, whichever device sent the request. In embodiments, the request identifier may be created when a data is collected and analyzed for a particular business transaction. Additional information regarding collecting data for analysis is discussed in U.S. patent application no. U.S. patent application Ser. No. 12/878,919, titled “Monitoring Distributed Web Application Transactions,” filed on Sep. 9, 2010, U.S. Pat. No. 8,938,533, titled “Automatic Capture of Diagnostic Data Based on Transaction Behavior Learning,” filed on Jul. 22, 2011, and U.S. patent application Ser. No. 13/365,171, titled “Automatic Capture of Detailed Analysis Information for Web Application Outliers with Very Low Overhead,” filed on Feb. 2, 2012, the disclosures of which are incorporated herein by reference.

Each of application servers 140, 150 and 160 may include an application and agents. Each application may run on the corresponding application server. Each of applications 142, 152 and 162 on application servers 140-160 may operate similarly to application 132 and perform at least a portion of a distributed business transaction. Agents 144, 154 and 164 may monitor applications 142-162, collect and process data at runtime, and communicate with controller 190. The applications 132, 142, 152 and 162 may communicate with each other as part of performing a distributed transaction. In particular each application may call any application or method of another virtual machine.

Asynchronous network machine 170 may engage in asynchronous communications with one or more application servers, such as application server 150 and 160. For example, application server 150 may transmit several calls or messages to an asynchronous network machine. Rather than communicate back to application server 150, the asynchronous network machine may process the messages and eventually provide a response, such as a processed message, to application server 160. Because there is no return message from the asynchronous network machine to application server 150, the communications between them are asynchronous.

Data stores 180 and 185 may each be accessed by application servers such as application server 150. Data store 185 may also be accessed by application server 150. Each of data stores 180 and 185 may store data, process data, and return queries received from an application server. Each of data stores 180 and 185 may or may not include an agent.

Controller 190 may control and manage monitoring of business transactions distributed over application servers 130-160. In some embodiments, controller 190 may receive application data, including data associated with monitoring client requests at client 105 and mobile device 115, from data collection server 160. In some embodiments, controller 190 may receive application monitoring data and network data from each of agents 112, 119, 134, 144 and 154. Controller 190 may associate portions of business transaction data, communicate with agents to configure collection of data, and provide performance data and reporting through an interface. The interface may be viewed as a web-based interface viewable by client device 192, which may be a mobile device, client device, or any other platform for viewing an interface provided by controller 190. In some embodiments, a client device 192 may directly communicate with controller 190 to view an interface for monitoring data.

Client device 192 may include any computing device, including a mobile device or a client computer such as a desktop, work station or other computing device. Client computer 192 may communicate with controller 190 to create and view a custom interface. In some embodiments, controller 190 provides an interface for creating and viewing the custom interface as a content page, e.g., a web page, which may be provided to and rendered through a network browser application on client device 192.

Applications 132, 142, 152 and 162 may be any of several types of applications. Examples of applications that may implement applications 132-162 include a Java, PHP, .Net, Node.JS, and other applications.

FIG. 2 is a method for monitoring a distributed business transaction. Agents may be installed at step 210. Agent installation may be performed over a network, through use of an install disk on a machine, or some other method. One or more types of agents may be installed on the machine for a variety of purposes. In some instances, an agent may be implemented based on a language implementing an application (Java, .Net, C++, or other language), or based on the type of machine to collect machine information.

Applications may be monitored by agents executing on the particular machine at step 220. The agents may monitor the application execution as well as performance of the machine on which the application is executed. The agents may monitor application performance, application and resource execution start time and stop time, as well as the threads handling the resource and application execution.

Business transaction, application, and machine data may be collected by one or more agents on a particular machine at step 230. The data may be collected, aggregated, and stored locally by the agents. The collected business transaction data may include information about the business transaction, including identification information, call chain data that identifies a string of applications that has been called in the past as part of executing a business transaction, and other information. In some instances, a portion of a call chain may be generated or modified, such as by adding the current application to the string of applications listed in the call chain, on the fly and maintained by agents as an application receives calls from other applications and makes calls to other applications and machines.

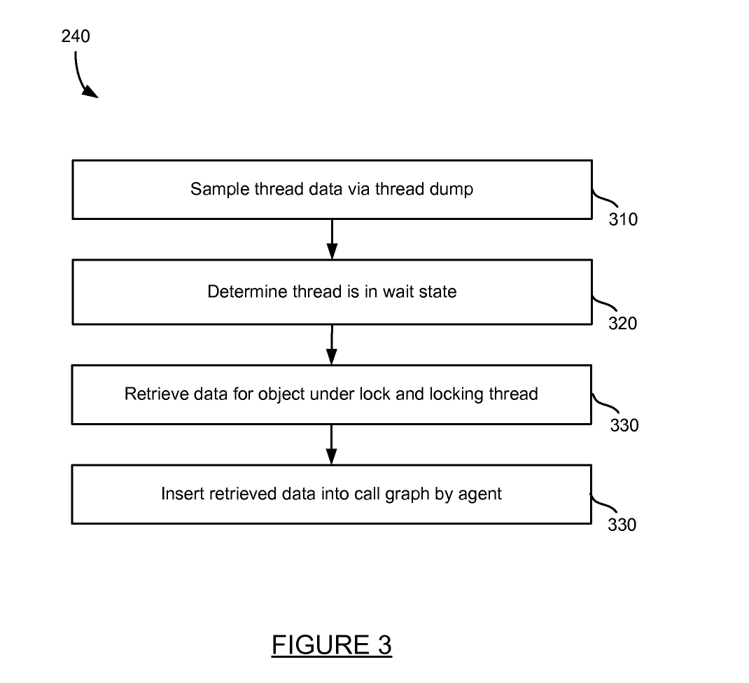

Resource contention data may be collected by an agent at step 240. When a resource is being executed by a first thread, it may cause a delay for another thread that needs to access the same resource. When this occurs, the two threads both contend for the same resource, one thread will be granted access to the resource, the resource will be locked while the granted thread uses the resource, and the other thread will be forced to wait until the thread granted access is done with the resource. Data collected for resource contention may include but is not limited to identification of the thread which has a lock on the resource, the thread which requests access to the locked resource, information about the resource itself. The contention data may be stored locally by the agent. More detail with respect to step 240 is discussed with respect to the method of FIG. 3.

Data collected by the agent may be reported to a remote server at step 250. The reported data may include business transaction data, application data, machine data, and resource contention data. The data may be reported in terms of a call graph from one or more agents to the controller (i.e., the remote server). For instance, the agents in the system of FIG. 1 may collect data over time, aggregate the data, and report the aggregated data in the form of a call graph to controller 190.

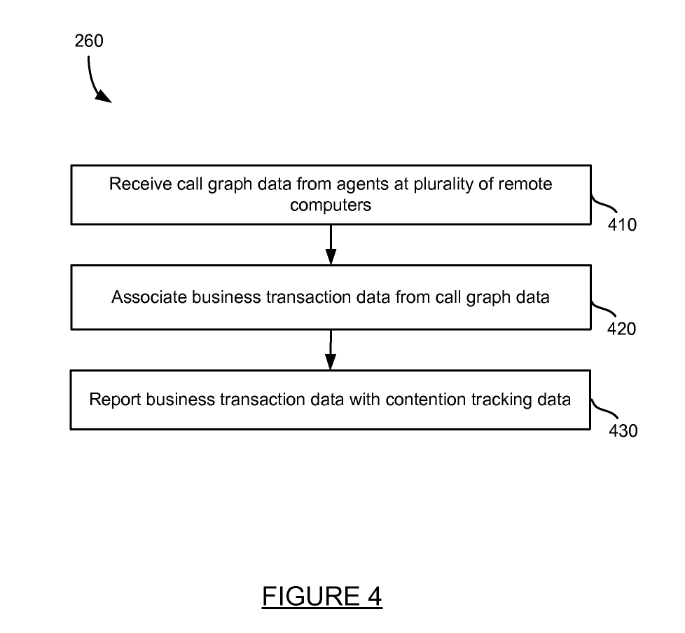

Data received by controller 190 may be analyzed and reported at step 260. Reported data may include business transaction performance data that includes contention tracking data. The contention tracking data may allow an administrator to see how a particular business transaction performed in view of resources that were requested but not readily available, causing that particular business transaction to wait until the resource was available. More detail for step 260 is discussed with respect to the method of FIG. 4.

FIG. 3 is a method for collecting resource contention data by an agent. The method of FIG. 3 provides more detail for step 240 of the method of FIG. 4. First, thread data may be sampled at step 310. The thread data may be sampled in a variety of ways depending on the application being monitored. For example, in the context of a Java virtual machine, thread data may be sampled by a thread dump initiated by the agent. The data acquired from the thread sampling may include the thread name, the current state of the thread, thread header information, and other data.

A determination is made at step 320 that a thread is in a wait state. The wait state may be determined from the thread stack data collected at step 310. In particular, the thread may indicate it is the waiting access to a particular resource that has been requested by the thread.

Data for the resource under lock by another thread and identification information for the thread that owns the lock on the resource may be retrieved at step 330. This data may be retrieved from the thread at step 310 or by an additional request at some other time. The data for the resource under lock may include the name of the resource as well as a line of code at which the resource exists. The locking thread may include information about the thread that is access to the resource when the current thread request the access to that resource. The retrieved data may be inserted into a call graph by the agent at step 330. The call graph may indicate a series of calls made by the thread as part of execution of the current business transaction. The call graph may indicate a hierarchy of calls, such as a root call by the thread to a first resource, calls made by that resources to other resources, and so forth as part of the hierarchy that comprises a series of calls that form the business transaction. Information regarding the wait time that a thread experiences before being allowed access to a particular resource is inserted into the call graph at step 330.

FIG. 4 is a method for analyzing and reporting data by remote server. The method of FIG. 4 provides more detail of step 260 of the method of FIG. 2. First, call graph data is received from agents at a plurality of remote computers at step 410. Remote computers, such as application servers 130, 140, 150 and 160 in the system of FIG. 1, may each report data can to controller 190. The data reported by the application server agents may include call graph data collected by one or more agents at each application servers. Business transaction data from the call graph data is associated together at step 420. Associating business transaction data may include stitching together portions of a distributed business transaction that are performed at different application servers yet are part of the same business transaction. For example, a particular business transaction may be performed on an application server 130 as well as application server 140 and application server 160. In this instance, each of agents 134, 144, and 164 on those respective application servers will report a call graph associated with that business transaction to controller 190. Controller 190 receives the call graphs from the different agents but associated with the same business transaction, stitches the performance data included in the call graphs together, and generates performance data for the single business transaction that occurred over those three application servers.

Business transaction data that includes contention tracking data is reported by the controller at step 430. The business transaction data may include response time, resource loading time, database access time, and other data associated with the performance of a business transaction carried out over a distributed set of application servers. With respect to the contention tracking data, information regarding weight times experienced by a thread while trying to access and resource may be reported as part of the business transaction performance data.

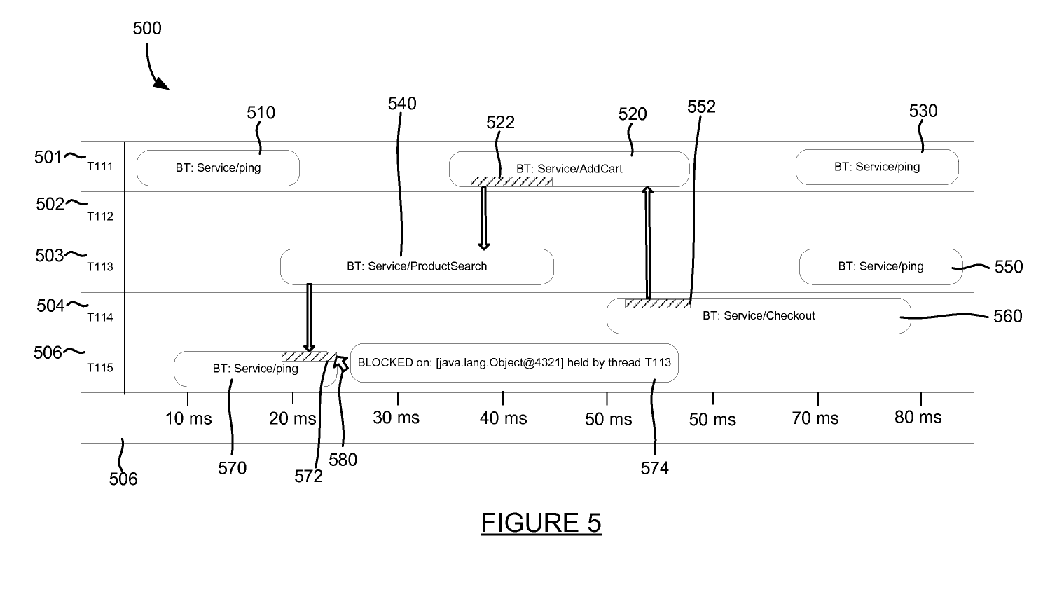

FIG. 5 is an illustration of a graphical user interface for reporting thread contention information. The interface 500 of FIG. 5 includes thread timelines 601, 602, 603, 604, and 605, and business transaction representations 610, 620, 630, 640, 650, 660, and 670. Each thread timeline may include any number of business transaction indicators. For example, thread timeline 601 corresponding to thread T111 includes business transaction indicators 610, 620, and 630. The business transaction indicators include the name of the business transaction and have a length that corresponds to the time of execution for the business transaction, according to a timeline at the bottom of the interface.

Contention information is provided through shaded portions within a business transaction indicator and arrows that associate the shaded portion with another business transaction. For example, business transaction indicator 620 includes shaded portion 622. This indicates that business transaction 620 waited for a resource locked by another thread for a time period represented by the shaded portion 622. The arrow extending from shaded portion 622 from business transaction indicator 622 to business transaction indicator 640 indicates that the wait time represented by shaded portion 622 is due to thread T113 having a lock on the particular resource. In particular, thread T113 has a lock on the resource required by thread T111 to execute business transaction 620 when T113 was executing business transaction 640. Similarly, the arrow from business transaction indicator 660, in particular the shaded portion 662, indicates that business transaction 660 waited for a time associated with shaded portion 662 for business transaction 622 to use and release a resource owned by a thread T111.

Additional contention data may be provided to a user within graphical user interface of FIG. 5. For example, if a user provides an input to a particular shaded portion, such as by placing a cursor 680 over a shaded portion 672, graphical user interface may provide information regarding the resource requested by a particular business transaction and a thread that held a lock on that resource. For example, pop-up window 674 indicates that for shaded portion 672, the request made by thread 115 was blocked for the resource named “java.lang.object” at program code line 4321, which was held or locked by thread T113. With this information, an administrator may quickly determine the amount of time a business transaction execution was spent on waiting for other resources, what the resource is, and what thread had a lock on the particular resource.

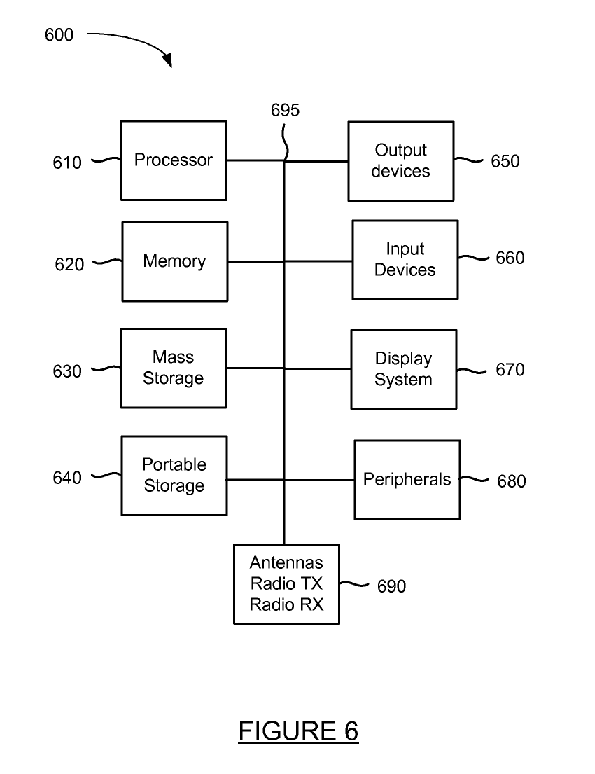

FIG. 6 is a block diagram of a system for implementing the present technology. System 600 of FIG. 6 may be implemented in the contexts of the likes of client computer 105 and 192, servers 125, 130, 140, 150, and 160, machine 170, data stores 180 and 190, and controller 190. The computing system 600 of FIG. 6 includes one or more processors 610 and memory 620. Main memory 620 stores, in part, instructions and data for execution by processor 610. Main memory 620 can store the executable code when in operation. The system 600 of FIG. 6 further includes a mass storage device 630, portable storage medium drive(s) 640, output devices 650, user input devices 660, a graphics display 670, and peripheral devices 680.

The components shown in FIG. 6 are depicted as being connected via a single bus 690. However, the components may be connected through one or more data transport means. For example, processor unit 610 and main memory 620 may be connected via a local microprocessor bus, and the mass storage device 630, peripheral device(s) 680, portable storage device 640, and display system 670 may be connected via one or more input/output (I/O) buses.

Mass storage device 630, which may be implemented with a magnetic disk drive, an optical disk drive, a flash drive, or other device, is a non-volatile storage device for storing data and instructions for use by processor unit 610. Mass storage device 630 can store the system software for implementing embodiments of the present invention for purposes of loading that software into main memory 620.

Portable storage device 640 operates in conjunction with a portable non-volatile storage medium, such as a floppy disk, compact disk or Digital video disc, USB drive, memory card or stick, or other portable or removable memory, to input and output data and code to and from the computer system 600 of FIG. 6. The system software for implementing embodiments of the present invention may be stored on such a portable medium and input to the computer system 600 via the portable storage device 640.

Input devices 660 provide a portion of a user interface. Input devices 660 may include an alpha-numeric keypad, such as a keyboard, for inputting alpha-numeric and other information, a pointing device such as a mouse, a trackball, stylus, cursor direction keys, microphone, touch-screen, accelerometer, and other input devices Additionally, the system 600 as shown in FIG. 6 includes output devices 650. Examples of suitable output devices include speakers, printers, network interfaces, and monitors.

Display system 670 may include a liquid crystal display (LCD) or other suitable display device. Display system 670 receives textual and graphical information, and processes the information for output to the display device. Display system 670 may also receive input as a touch-screen.

Peripherals 680 may include any type of computer support device to add additional functionality to the computer system. For example, peripheral device(s) 680 may include a modem or a router, printer, and other device.

The system of 600 may also include, in some implementations, antennas, radio transmitters and radio receivers 690. The antennas and radios may be implemented in devices such as smart phones, tablets, and other devices that may communicate wirelessly. The one or more antennas may operate at one or more radio frequencies suitable to send and receive data over cellular networks, Wi-Fi networks, commercial device networks such as a Bluetooth devices, and other radio frequency networks. The devices may include one or more radio transmitters and receivers for processing signals sent and received using the antennas.

The components contained in the computer system 600 of FIG. 6 are those typically found in computer systems that may be suitable for use with embodiments of the present invention and are intended to represent a broad category of such computer components that are well known in the art. Thus, the computer system 600 of FIG. 6 can be a personal computer, hand held computing device, smart phone, mobile computing device, workstation, server, minicomputer, mainframe computer, or any other computing device. The computer can also include different bus configurations, networked platforms, multi-processor platforms, etc. Various operating systems can be used including Unix, Linux, Windows, iOS, Android, C, C++, Node.JS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

1-24. (canceled)

25. A method for monitoring a distributed business transaction performed over multiple computers connected over a network, the method comprising:
collecting, by a first agent installed on a first computer of the multiple computers performing the distributed business transaction, business transaction data including identification information about the distributed business transaction and call chain data that identifies applications that have been called as part of executing the business transaction;
modifying the call chain data on the fly to include additional calls made to and from additional applications;
collecting, by the first agent, resource contention data indicating that multiple threads involved in performing the business transaction are contending for the same resource, that one of the multiple threads has access to the same resource, locked out at least one other of the multiple threads from accessing the same resource, and caused delay for the locked out at least one other of the multiple threads in accessing the same resource;
storing the collected resource contention data including identification of the thread that locked the same resource, identification of the at least one other of the multiple threads that is locked out from accessing the same resource, and identification of the same resource contended by the multiple threads;
aggregating the collected business transaction data and the resource contention data;
transmitting, by the first agent, the aggregated resource contention data and the business transaction data to a remote server, wherein the aggregated resource contention data and the business transaction data are associated with each other on a visual display.

26. The method of claim 25, including displaying the resource contention data and the business transaction data in a call graph that indicate a hierarchy of calls made as part of execution of the business transaction.

27. The method of claim 25, including tracking the resource contention data including the delay caused by the multiple threads contending for the same resource causing a delay to the business transaction.

28. The method of claim 25, wherein the resource contention data include a name of the same resource and identification of a line of code at which the same resource is located.

29. The method of claim 25, wherein collecting the resource contention data include performing a thread dump to sample each thread.

30. The method of claim 25, wherein the resource contention data includes a wait time for the at least one other of the multiple threads that is locked out from accessing the same resource thread waited for the locked resource to become available.

31. The method of claim 25, including determining a time line for the thread having access to the same resource and a timeline for the at least one other of the multiple threads locked out from accessing the same resource.

32. The method of claim 25, including determining that the at least one other of the multiple threads locked out from accessing the same resource is in a wait state waiting for the locked resource to become available.

33. A non-transitory computer readable storage medium having embodied thereon a program, the program including instructions executable by a processor to perform a method for monitoring a distributed business transaction performed over multiple computers connected over a network, the method comprising:
collecting, by a first agent installed on a first computer of the multiple computers performing the distributed business transaction, business transaction data including identification information about the distributed business transaction and call chain data that identifies applications that have been called as part of executing the business transaction;
modifying the call chain data on the fly to include additional calls made to and from additional applications;
collecting, by the first agent, resource contention data indicating that multiple threads involved in performing the business transaction are contending for the same resource, that one of the multiple threads has access to the same resource, locked out at least one other of the multiple threads from accessing the same resource, and caused delay for the locked out at least one other of the multiple threads in accessing the same resource;
storing the collected resource contention data including identification of the thread that locked the same resource, identification of the at least one other of the multiple threads that is locked out from accessing the same resource, and identification of the same resource contended by the multiple threads;
aggregating the collected business transaction data and the resource contention data;
transmitting, by the first agent, the aggregated resource contention data and the business transaction data to a remote server, wherein the aggregated resource contention data and the business transaction data are associated with each other on a visual display.

34. The non-transitory computer readable storage medium of claim 36, including displaying the resource contention data and the business transaction data in a call graph that indicate a hierarchy of calls made as part of execution of the business transaction.

35. The non-transitory computer readable storage medium of claim 36, including tracking the resource contention data including the delay caused by the multiple threads contending for the same resource causing a delay to the business transaction.

36. The non-transitory computer readable storage medium of claim 36, wherein the resource contention data include a name of the same resource and identification of a line of code at which the same resource is located.

37. The non-transitory computer readable storage medium of claim 36, wherein collecting the resource contention data include performing a thread dump to sample each thread.

38. The non-transitory computer readable storage medium of claim 36, wherein the resource contention data includes a wait time for the at least one other of the multiple threads that is locked out from accessing the same resource thread waited for the locked resource to become available.

39. The non-transitory computer readable storage medium of claim 36, including determining a time line for the thread having access to the same resource and a timeline for the at least one other of the multiple threads locked out from accessing the same resource.

40. The non-transitory computer readable storage medium of claim 36, including determining that the at least one other of the multiple threads locked out from accessing the same resource is in a wait state waiting for the locked resource to become available.

41. A system for monitoring a distributed business transaction performed over multiple computers, comprising:
a server including a memory and a processor; and
one or more modules stored in the memory and executed by the processor to perform operations including:
receive, from each of a first agent installed on a first computer and a second agent installed on a second computer of the multiple computers performing the distributed business transaction, aggregated business transaction data including identification information about the distributed business transaction and call chain data that identifies applications that have been called as part of executing the business transaction;
modify the call chain data on the fly to include additional calls made to and from additional applications;
receive, from the first agent and the second agent, resource contention data indicating that multiple threads involved in performing the business transaction are contending for the same resource, that one of the multiple threads has access to the same resource, locked out at least one other of the multiple threads from accessing the same resource, and caused delay for the locked out at least one other of the multiple threads in accessing the same resource;
wherein the received resource contention data include identification of the thread that locked the same resource, identification of the at least one other of the multiple threads that is locked out from accessing the same resource, and identification of the same resource contended by the multiple threads; and
generate performance data for the business transaction performed over the first and second computers by stitching together the resource contention data and the business transaction data received from the first and second agent installed on the first and second computers respectively, wherein the resource contention data and the business transaction data are associated with each other on a visual display.

42. The system of claim 41, wherein the one or more modules stored in the memory is executed by the processor to perform operations including display the resource contention data and the business transaction data in a call graph that indicate a hierarchy of calls made as part of execution of the business transaction.

43. The system of claim 41, wherein the one or more modules stored in the memory is executed by the processor to perform operations including track the resource contention data including the delay caused by the multiple threads contending for the same resource causing a delay to the business transaction.

44. The system of claim 41, wherein the resource contention data include a name of the same resource and identification of a line of code at which the same resource is located.

45. The system of claim 41, wherein the resource contention data includes information on how long the at least one of the multiple threads locked out from accessing the same resource had to wait before the same resource became available.

46. The system of claim 41, wherein the resource contention data includes a series of calls made by the at least one of the multiple threads locked out from accessing the same resource.

47. The system of claim 41, wherein the one or more modules stored in the memory is executed by the processor to perform operations including determine a time line for the thread having access to the same resource and a timeline for the at least one other of the multiple threads locked out from accessing the same resource.

48. The system of claim 41, wherein the one or more modules stored in the memory is executed by the processor to perform operations including determine that the at least one other of the multiple threads locked out from accessing the same resource is in a wait state waiting for the locked resource to become available.
